(19) United States
(12) Patent Application Publication
(10) Pub. No.: US 2026/0317233 A1
(43) Pub. Date: Oct. 15, 2026

(54) REFLECTIVE SILICA-BASED GRANULES AND POWDER FOR USE IN ROOFING AND ARCHITECTURAL MATERIALS AND PROCESSES FOR MAKING THE SAME

(71) Applicant: Covia Solutions LLC, Independence, OH (US)

(72) Inventors: John Squires Jackson, The Woodlands, TX (US); Claud Eric Westbrook, Conroe, TX (US)

(73) Assignee: Covia Solutions LLC, Independence, OH (US)

(21) Appl. No.: 19/104,564

(22) PCT Filed: Aug. 21, 2023
(86) PCT No.: PCT/US2023/072546

§ 371 Date: Feb. 18, 2025

Related U.S. Application Data
(60) Provisional application No. 63/373,291, filed on Aug. 23, 2022.

(51) Int. Cl. C04B 18/04; C04B 20/02; C04B 20/04; C04B 20/10; C04B 111/00; C04B 111/80

(52) U.S. Cl. CPC C04B 18/0481; C04B 20/026; C04B 20/04; C04B 20/10; C04B 2111/0025; C04B 2111/00586; C04B 2111/80

(57) ABSTRACT

A process for producing a white silica-based product, such as a granule (e.g., a roofing granule) comprises milling a feed material to form a milled feed material having a size of from about 0.5 μm to about 50 μm; combining the milled feed material with a binding agent and water to provide an agglomerated mixture; and heating the agglomerated mixture for a time and at a temperature of from about 1350° C. to less than about 1550° C. to form the white silica-based product. The agglomerated mixture is heated sufficiently so that cristobalite is the predominant silica crystal structure in the white silica-based product and further so that the white silica-based product exhibits an L* value in the CIELAB color space of 93-98.

### BACKGROUND

Mineral granules can help retain the integrity of roofing and other architectural products during exposure to an outdoor environment. Specifically, granules can protect and preserve the roofing and architectural products from wear and abrasion caused by rain, snow, ice and wind and from damage caused by solar ultraviolet radiation, and can also serve other purposes such as providing an aesthetic appeal to the roof and reflectance of solar energy and light. In some locations, building codes require roofs to have certain properties, such as a minimum solar reflectance. Mineral powders can be added to paints and surface coating materials to provide reflectance of light for enhanced visibility, for example, use as lane and road markings on pavement.

A variety of materials have been proposed to provide solar and light reflectance, although many of the materials do not satisfy other requirements for roofing, architectural and coating materials. Still other materials that have been proposed to provide reflectance are too costly for incorporation into roofing and other architectural and coating materials.

### SUMMARY

In aspects of the present disclosure, a process for producing a white silica-based product comprises milling a feed material to form a milled feed material having a size of from about 0.5 μm to about 50 μm; combining the milled feed material with a binding agent (e.g., sodium silicate) and water to provide an agglomerated mixture; and heating the agglomerated mixture for a time and at a temperature of from about 1300° C. to less than about 1550° C. to form the white silica-based product. The agglomerated mixture is heated sufficiently so that cristobalite is the predominant silica crystal structure in the white silica-based product and further so that the white silica-based product exhibits an L* value in the CIELAB color space of 93-98.

In some aspects, the feed material is derived from a waste sand by-product produced from a sand plant. In some aspects, the binding agent is present in an amount of from about 0.2 wt. % to about 10 wt. % based on a total weight of the agglomerated mixture, or the binding agent is present in an amount of from about 1 wt. % to about 5 wt. % based on a total weight of the agglomerated mixture.

In some aspects, the water is present in an amount of from about 10 wt. % to about 20 wt. % based on a total weight of the agglomeration mixture, or the water is present in an amount of from about 12 wt. % to about 16 wt. % based on a total weight of the agglomeration mixture.

In some aspects, the agglomerated mixture further comprises sodium hydroxide.

In some aspects, the binding agent and the water are applied to the milled feed material via spraying. In some aspects, heating comprises heating the agglomerated mixture to a temperature of from about 1350° C. to about 1400° C. According to some aspects, the heating is carried out for a time of from about 40 minutes to about 60 minutes. In some aspects, the heating is effective to sinter particles of the agglomerated mixture into granules.

In some aspects, the process further includes cooling the white silica-based product to a temperature of about 100° C. or less. In some aspects, the process further includes applying at least one coating to granules of the white silica-based product at a temperature of from about 75° C. to about 100° C. In other aspects, the process includes applying at least one coating to granules of the white silica-based product of a temperature of less than 50° C. In some aspects, the process further includes sieving the white silica-based product to select white silica-based granules having an average particle size of from about 0.45 mm to about 2.5 mm.

According to some aspects, the white silica-based granules have a specific gravity of from about 2.32 to about 2.40. In some aspects, the sieving is effective to create an over-sized white silica fraction and an under-sized white silica fraction, and the process further includes combining the over-sized white silica fraction and the under-sized white silica fraction; and milling the combined fractions, thereby producing a white silica-based powder having a maximum mesh size of 325 mesh.

According to various aspects of the present disclosure, a roofing granule comprises a white silica-based granule exhibiting an L* value in the CIELAB color space of 93-98, wherein cristobalite is the predominant crystal structure of silica in the white silica-based granule.

In some aspects, the roofing granule has an average particle size of from about 0.45 mm to about 2.5 mm. In some aspects, the roofing granule has a specific gravity of from about 2.32 to about 2.40. In some aspects, the roofing granule has a functional coating on an exterior surface of the white silica-based granule.

According to various aspects of the present disclosure, a white silica-based granule exhibits a visible light reflection of greater than 75% in the 360 nm to 750 nm wavelength range and at least one of the following: an L* value in the CIELAB color space of 93-98; or cristobalite is the predominant silica crystal structure; or the granule has a specific gravity of from about 2.32 to about 2.40.

### BRIEF DESCRIPTION OF THE DRAWINGS

FIG. 1A is a photograph showing the feed material of Sample A as described in the Example;

FIG. 1B is a photograph showing the resulting coarse material of Comparative Sample D formed from heat treating the feed material of Sample A as described in the Example;

FIG. 1C is a photograph showing the resulting granules of Sample E formed from the feed material of Sample A as described in the Example;

FIG. 2 is a photograph showing the resulting granules of Sample F formed from the feed material of Sample B as described in the Example;

FIG. 3 is a graph of the % reflectance (Y-axis) as a function of wavelength (X-axis; in nm) for various Samples described herein.

### DETAILED DESCRIPTION

The present disclosure provides white, and in some aspects ultra-white, silica products in the form of powders or granules having high reflectivity and suitable for use as roofing granules and powders for coatings and architectural materials. The ultra-white filler of choice for many of these products is cristobalite, because of its high degree of whiteness and relatively low cost. Although naturally occurring, cristobalite used for making man-made products is typically produced by heating quartz sand—i.e., sand which is substantially silica having a quartz crystalline structure—until essentially all of its quartz content has been transformed into other forms of silica, including cristobalite. Normally, this is done by heating the quartz sand to ≥1550° C. for ≥1 hour in a rotary kiln adapted to cause the sand to tumble over itself as it travels from the kiln's inlet to its outlet. This produces an ultra-white cristobalite product which exhibits an L* value in the CIELAB color space of 97 or more and which contains at least about 85 wt. % cristobalite based on a total weight of crystalline silica and less than 1 wt. % quartz based on the total weight of crystalline silica. The ultra-white cristobalite product also typically includes some amount of amorphous silica, typically about 5 wt. % or more based on a total weight of silica contained in the ultra-white cristobalite product. However, in order to obtain an ultra-white product, a high quality sand must be used as input.

The present disclosure provides a process for producing a white silica-based product, such as a granule (e.g., a roofing granule) comprises milling a feed material to form a milled feed material having a size of from about 0.5 μm to about 50 μm; combining the milled feed material with sodium silicate and water to provide an agglomerated mixture; and heating the agglomerated mixture for a time and at a temperature of from about 1300° C. to less than about 1550° C. to form the white silica-based product. The agglomerated mixture is heated sufficiently so that cristobalite is the predominant silica crystal structure in the white silica-based product and further so that the white silica-based product exhibits an L* value in the CIELAB color space of 93-98. The process enables a white or ultra-white silica-based product to be produced from alternative sand input sources.

### Silica Feed Material

The silica feed material which is subjected to the thermal treatment process of this invention will normally contain greater than or equal to about 98 wt. % silica, including greater than or equal to 99.5 wt. % silica, with about 95% or more of the silica being quartz silica based on a total weight of the silica included in the silica feed material. In this context, “quartz silica” means silica having a quartz crystal structure. Thus, this feed material will normally contain about 93 wt. % (~98 wt. %×95%=~93 wt. %), or more, including 94.5 wt. % (~99.5 wt. %×95%=~94.5 wt. %) or more of quartz silica. In various embodiments, the silica feed material includes from about 98 wt. % to about 99.8 wt. % silica, and from about 93 wt. % to about 99 wt. % quartz silica. Accordingly, although the processes described herein utilize a reasonably pure quartz silica sand, as discussed above, it should be understood that the process does not require the highest purity of quartz silica sand as feed material.

Quartz sand ore processing normally begins with a series of steps carried out to liberate the desired quartz ore from gross impurities. These steps typically include crushing (if hard rock or sandstone), scrubbing, washing, hydro-sizing and desliming. If the ore contains dissimilar materials such as feldspar, garnets and mica, flotation may also be needed. Magnetic separation can also be used for removing magnetic or para-magnetic particles. Thereafter, the cleaned ore is normally dried and classified by size, which is typically done by bulk dewatering using cyclones and/or pile draining, heating to dryness (e.g., less than about 1 wt. % water) and sizing via screens or sifters.

However, in embodiments described herein, the feed material may be raw quartz sand which already has the desired relatively high level of silica purity or which can be easily and inexpensively cleaned such as by scrubbing, washing, hydro-sizing, desliming and the like to achieve this relatively high level of silica purity.

In this context, “raw quartz sand” will be understood to mean a naturally-occurring free-flowing, sand in which at least 95 wt. % of the silica present has a quartz crystal structure.

In addition, “naturally-occurring” will be understood to mean that, prior to when the thermal treatment process of this invention begins, the silica feed material has not been treated so as to convert it chemically to another material such as occurs, for example, when quartz silica is converted into an alkali metal silicate, an alkoxy silane or a hydrolyzed silica or to convert it physically to another material such as occurs, for example, when particulate silica is transformed into a silica sol or water-glass or when particulate silica is fired/sintered at temperatures high enough to change the phase structure of the silica from crystalline to amorphous and/or to change the shape of the silica particle to more-nearly spherical. Thus, “naturally-occurring” means that the particulate product is found essentially as is in nature such as occurs, for example, in the case of beach sand, quarry sand, and sand obtained by crushing sandstone and the like.

Unless otherwise indicated, all mesh sizes disclosed herein refer to mesh (U.S.).

Due to variations in feed materials and accuracy of measurement issues, it will be understood that “about” in connection with the above concentrations means that the above numbers have an accuracy of ±3 wt. %, more typically ±2 wt. %, ±1 wt. %. and even ±0.1 wt. % are also possible.

Unless otherwise indicated, “a white silica-based product” includes white or ultra-white silica-based granules in accordance with the present disclosure, a white or ultra-white silica-based powder in accordance with the present disclosure, or combinations thereof.

Finally, “cleaned” and “cleaning” as it relates to raw quartz sand will be understood to mean removing non-siliceous ingredients from the surfaces of the raw quartz sand grains. It does not mean and excludes processes in which silica in the form of a water-soluble compound is extracted from the raw quartz sand grains, following which, silica is recovered from the extracted water-soluble compound.

In any event, it should be understood that the feed material may contain some small amount of impurities, typically greater than or equal to about 0.2 wt. %, greater than or equal to about 0.5 wt. %, greater than or equal to about 0.6 wt. %, greater than or equal to about 0.7 wt. %, greater than or equal to about 0.8 wt. %, or greater than or equal to about 0.9 wt. %. In addition, in most instances, the feed material will not contain more than 2.0 wt. %, or more than 1.0 wt. %, of these impurities. Accordingly, in various embodiments, the feed material may contain from about 0.2 wt. % to about 2.0 wt. %, from about 0.5 wt. % to about 2.0 wt. %, from about 0.6 wt. % to about 2.0 wt. %, from about 0.7 wt. % to about 2.0 wt. %, from about 0.8 wt. % to about 2.0 wt. %, from about 0.9 wt. % to about 2.0 wt. %, from about 0.2 wt. % to about 1.5 wt. %, from 0.5 wt. % to about 1.5 wt. %, from about 0.6 wt. % to about 1.5 wt. %, from about 0.7 wt. % to about 1.5 wt. %, from about 0.8 wt. % to about 1.5 wt. %, from about 0.9 wt. % to about 1.5 wt. %, from about 0.2 wt. % to about 1.0 wt. %, from about 0.5 wt. % to about 1.0 wt. %, from about 0.6 wt. % to about 1.0 wt. %, from about 0.7 wt. % to about 1.0 wt. %, or from about 0.8 wt. % to about 1.0 wt. % of impurities based on a total weight of the material, including any and all ranges and subranges therein.

In embodiments, the silica feed material will be a raw quartz sand having a particle size of 30 to 170 mesh (U.S.). However, feed materials with other particle sizes can also be used. Thus, the silica feed material can have a gravel particle size of 2.5 to 8 mesh (U.S.), a grit or coarse sand particle size of 8 to 70 mesh (U.S.), or a fine sand particle size of 70 to 170 mesh (U.S.). Silica feed material having a particle size of 140 to 200 mesh (U.S.) can also be used, depending on the particular embodiment. It should be understood that the milling process described hereinbelow can enable the use of silica feed material having a wide variety of particle sizes.

In various embodiments, waste sand fractions that are often found in various different sand plants may be used as a feed material. Many industrial sand plants are operated to produce sand fractions of different particle sizes and/or particle size distributions for making different products such as glass, proppants, play sand, concrete sand, etc. As a result, high quality, high purity sand fractions having particle sizes of limited commercial interest are often produced as by-products during the manufacture of commercial products. These sand fractions are either not used as all, or in some instances, must be discharged to waste such as by burying them underground or otherwise returning them to the mine, beach, or other geological location from which they were originally obtained. Accordingly, these sand fractions, hereinafter “waste sand by-products” either have no value at all or, more commonly, have a negative value due the cost of discharging them to waste.

In various embodiments, the feed material is subjected to a milling step. During the milling step, the feed material is milled to a maximum mesh size of approximately 325 mesh. Milling can be conducted using any suitable equipment and protocols known and used in the art. In embodiments, the milling is effective to form angular powder particles having a mean particle size of from about 10-15 μm. For example, the milling is effective to generate particles having a particle size of from about 0.5 μm to about 50 μm.

Following milling, the milled feed material is combined with a binding agent and water in an agglomeration step. In various embodiments, the milled feed material may be combined with water and a binding agent, a fluxing agent, or both a fluxing agent and a binding agent in an agglomeration step. In various embodiments, the binding agent is a sodium-containing binding agent, such as, by way of example and not limitation, sodium silicate. In embodiments, the fluxing agent is a sodium-containing fluxing agent, for example, sodium hydroxide. Without being bound by theory, it is believed that certain binding agents, such as sodium silicate, can act as both a binding agent (e.g., to bind particles to one another) and a fluxing agent (e.g., cause the crystal structure of the silica to change from quartz to cristobalite and/or tridymite under reduced thermal conditions than would otherwise be the case). In embodiments, the binding agent is present in an amount of from about 0.2 wt. % to about 10 wt. %, based on a total weight of the final product. For example, the binding agent can be present in an amount of from about 0.5 wt. % to about 10 wt. %, from about 0.5 wt. % to about 7.5 wt. %, from about 0.5 wt. % to about 5.0 wt. %, from about 1.0 wt. % to about 10 wt. %, from about 1.0 wt. % to about 7.5 wt. %, from about 1.0 wt. % to about 5.0 wt. %, from about 1.5 wt. % to about 10 wt. %, from about 1.5 wt. % to about 7.5 wt. %, from about 1.5 wt. % to about 5.0 wt. %, from about 2.0 wt. % to about 10 wt. %, from about 2.0 wt. % to about 7.5 wt. %, from about 2.0 wt. % to about 5.0 wt. %, from about 2.5 wt. % to about 10 wt. %, from about 2.5 wt. % to about 7.5 wt. %, or from about 2.5 wt. % to about 5.0 wt. % of the final product, including any and all ranges and subranges therein.

The water can be present in an amount of from about 10 wt. % to about 20 wt. %, based on a total weight of the final product. For example, the water can be present in an amount of from about 10 wt. % to about 20 wt. %, from about 11 wt. % to about 18 wt. %, or from about 12 wt. % to about 16 wt. %, including any and all ranges and subranges therein. Water can be added as a separate component into the agglomerated mixture, as part of the binding agent (e.g., when the binding agent is added in an aqueous form), or as a combination thereof. For example, in embodiments, the binding agent is added as a 40 wt. % active sodium silicate aqueous solution, and auxiliary water is also added to the milled feed material.

Although not limited by any particular method, in various embodiments, the binding agent and water are applied to the milled feed material via spraying or pouring a diluted aqueous binding agent into a granulator, including, but not limited to, an Eirich mixer. Regardless of the application method, the milled feed material, binding agent, and water are mixed and granulated to provide an agglomerated mixture, sometimes referred to herein as granules. In other embodiments, water and the binding agent, the fluxing agent, or both the binding agent and the fluxing agent are applied to the milled feed material and mixed to form granules. Although agglomeration can be conducted according to any suitable method known and used in the art, in various embodiments, the agglomeration can be carried out at ambient temperature.

### Thermal Processing

In accordance with various embodiments, the agglomerated mixture (i.e., the granules) flows into a rotary kiln where it is heated for a time and at a temperature which are sufficient to transform the crystal structure of a substantial amount of its silica content from quartz to cristobalite.

As previously indicated, using heat to transform quartz into cristobalite has been industrially practiced for many years. In various embodiments, a similar heating process is carried out except that substantially less energy is required, because substantially lower processing temperatures and substantially shorter processing times are used. In accordance various embodiments, it has been found that white or ultra-white silica-based products having whiteness levels approaching, and in some instances equaling, those exhibited by industrially-produced cristobalite can be achieved with this approach, even though substantially less thermal energy is used.

Thus, various embodiments provide a white or ultra-white silica-based product as an alternative product which performs essentially as well, or even just as well, as industrial cristobalite in many applications but at significantly lower cost.

In various embodiments, therefore, the agglomerated mixture is heated to a temperature of no more than about 1550° C. for no more than about an hour (i.e., about 60 minutes). In some embodiments, the agglomerated mixture is heated to a temperature of from about 1300° C. to about 1550° C., from about 1325° C. to about 1550° C., from about 1350° C. to about 1550° C., or from about 1375° C. to about 1550° C. for a time of from about 40 minutes to about 60 minutes. Although the temperature can vary depending on the particular embodiment, in general, the temperature can be high enough to achieve a primarily cristobalite silica composition. However, it is believed that the milling of the feed sand produces particles that can be converted to cristobalite at a lower temperature than is required according to conventional methods. Moreover, the temperature can be sufficient to sinter the particles into cohesive granules, thereby providing mechanical integrity to the granules. Heating can be carried out, for example, in a continuous manner in a rotary kiln, although other methods of heating are possible and contemplated.

Thereafter, the white or ultra-white silica-based product is cooled to a temperature of about 100° C. or less, about 95° C. or less, about 75° C. or less, about 50° C. or less, or to room temperature (e.g., about 23° C.). In embodiments, the white or ultra-white silica-based product can be cooled via an air quenching process that uses forced convection of ambient air to expedite cooling. In some embodiments, one or more coatings can be applied during the cooling process. For example, a waterproofing or other functional coating can be applied to the white or ultra-white silica-based product while the white or ultra-white silica-based product is at a temperature of from about 75° C. to about 100° C., and the coated silica can then be cooled to room temperature. As another example, a functional coating can be applied to the white or ultra-white silica-based product while the white or ultra-white silica-based product is at a temperature of less than 50° C. For example, a functional coating can be applied to the white or ultra-white silica-based product at a temperature of from about 15° C. to about 50° C.

### White Silica-Based Granules

In various embodiments, the white or ultra-white silica-based product can be sieved for selection of granules having a particular size. Sieving can be carried out in any suitable method known and used in the art, including but not limited to the use of vibratory screens. In various embodiments, the granules are selected to have a particle size based on a −8/+35 mesh. In some embodiments, the granules have an average particle size of from about 0.45 mm to about 2.5 mm. However, in other embodiments, granules having larger or smaller particle sizes can be used, depending on the particular application. For example, when the granules are intended for use in roofing applications (e.g., applied to the surface of a shingle or flat top roof), the granules can be selected to have a standard size #11 granule size or another standard size that is commonly used in the roofing industry. In other applications, such as when the granules will be used as a filler for pigments, coarser or finer granules can be used. As will be described in greater detail below, in some embodiments, granules that are coarser and/or finer than the granule size for the particular embodiment can be further processed.

The shape of the white or ultra-white silica-based granules is typically round, although it is contemplated that the agglomeration process described above could be altered to achieve granules having other shapes.

The bulk density of the white or ultra-white silica-based granules is less than about 75 lb/ft³. For example, in various embodiments, the bulk density of the white or ultra-white granular silica-based filler is from about 30 lb/ft³ to about 75 lb/ft³, from about 35 lb/ft³ to about 75 lb/ft³, from about 40 lb/ft³ to about 75 lb/ft³, from about 45 lb/ft³ to about 75 lb/ft³, or from about 50 lb/ft³ to about 75 lb/ft³. In contrast, conventional granules of similar size have a bulk density of from about 80 lb/ft³ to about 120 lb/ft³. In various embodiments, the white or ultra-white granular silica-based filler has a specific gravity (via helium pycnometry) of from about 2.32 to about 2.40, depending on the temperature and retention time during thermal processing. This is in contrast to a specific gravity of about 2.65 for the feed material of particular embodiments. The specific gravity measurements of the granules via water pycnometry indicated a decrease of about 20% as compared to the feed material, suggesting a significant void volume within the granules that are produced by this method.

As previously mentioned, the white or ultra-white silica-based granules exhibit a very high L* value, approaching, and in some instances equaling, that of industrial cristobalite, even though the thermal processing conditions used to make it are substantially less severe than those used to make industrial cristobalite. In various embodiments, the white or ultra-white silica-based granules exhibit an L* value of from about 93 to about 98, such as from about 94 to about 97, from about 94 to about 98, from about 95 to about 98, from about 96 to about 98, from about 93 to about 97, from about 93 to about 96.5, from about 93 to about 96, from about 93 to about 95, or from about 95 to about 96.5. Moreover, in various embodiments, the white or ultra-white silica-based granules exhibit an average visible light reflectance of between about 75% and about 85%, such as from about 77% to about 83% or from about 79% to about 82%.

### White Silica-Based Powder

As described above, in various embodiments, the white or ultra-white silica-based product is sieved to select white or ultra-white silica-based granules having a particular size. Accordingly, in addition to the selected white or ultra-white silica-based granules, an over-sized white or ultra-white silica fraction (e.g., particles having a particle size greater than 8 mesh or approximately 2.5 mm) and an under-sized white or ultra-white silica fraction (e.g., particles having a particle size less than 35 mesh or approximately 0.45 mm) are created.

Therefore, in some embodiments, following thermal processing and sieving, the over-sized white or ultra-white silica fraction and the under-sized white or ultra-white silica fraction are combined for further processing. Like the white or ultra-white silica-based granules described above, the over-sized white or ultra-white silica fraction and the under-sized white or ultra-white silica fraction are primarily cristobalite and has a specific gravity (via helium pycnometry) of from about 2.32 to about 2.40, depending on the temperature and retention time during thermal processing. The combined fractions can then be milled or ground to produce a powder having a maximum mesh size of 325 mesh. The grinding or milling can be carried out according to any method known and used in the industry, and can be the same as or different from the grinding or milling method utilized prior to thermal processing. For example, in some embodiments, the combined fractions are milled using a ball mill with alumina media to a particle size distribution such that about 97% of the resulting powder distribution mass is finer than approximately −325 mesh. Conventional air classification may be used to control the top size of the white or ultra-white silica-based powder to be less than 325 mesh. In other words, in various embodiments, the white or ultra-white silica-based powder has a particle size of approximately 44 microns or less.

In some embodiments, the granules described hereinabove can be milled as an alternative to or in addition to one or both of the white or ultra-white silica fractions to create the white or ultra-white silica-based powder. For example, following sieving, the selected granules can be milled using a ball mill to produce the white or ultra-white silica-based powder. In other embodiments, the sieving step can be omitted and the white or ultra-white silica-based product can be milled using a ball mill to produce the white or ultra-white silica-based powder.

The white or ultra-white silica-based powder can be used in a variety of applications, including as a filler or as feed material for another granulation process. Other applications are also contemplated and known in the art.

### Man-Made Products

The white or ultra-white silica-based granules and/or white or ultra-white silica-based powder can be used to produce a wide variety of different man-made products, including both solid shaped articles as well as binders, sealants, coatings and adhesives.

Examples of solid shaped articles include engineered stone such as used to make synthetic kitchen countertops, artificial rocks such as used to finish fireplaces and exterior building walls, tile, brick, and white architectural concrete. Such products typically contain one or more fillers or aggregates and at least one or more binders which may be cement, resinous or both. The white or ultra-white silica-based products (powders or granules) can replace these fillers and/or aggregates. Portland cement (normally including a whitener such as titanium dioxide, calcium carbonate, or cristobalite) is the most common binder, although other binders including pozzolan-based binders, other hydraulic lime-based cements and the like can also be used. Moreover, in some embodiments, the white or ultra-white silica-based granules can be used as granules on roofing shingles. For example, the white or ultra-white silica-based granules can be used as specialty granules on roofing shingles to provide increased solar reflectivity as compared to conventional standard roofing granules. Additionally or alternatively, the white or ultra-white silica-based granules and powder can be used to replace filler used in asphalt or other building products such as siding, paving and architectural coatings. The reflective powders can be added to paints and coatings for use as lane markers and other designations on roadway surfaces.

In accordance with various embodiments, the white or ultra-white silica-based product can be used to replace some or all of these conventional silica-based products, since it has been found that this material functions just as well as these materials in terms of the physical properties of the man-made products obtained at possibly lower cost, depending primarily on the degree of whiteness desired as well as other factors such as raw material supply, location, transportation costs, etc. In addition, because the L-value of the inventive white or ultra-white silica-based product approaches and sometimes equals that of conventionally formed, industrial cristobalite, further advantages in terms of product appearance can possibly be obtained by this approach.

### EXAMPLES

The following examples are included for the purposes of illustration and do not limit the general inventive concepts described herein.

### Example 1

To begin, optical properties of various feed materials were recorded. The feed material of Sample A was a raw coarse sand that was chemically “dirty” (e.g., contained greater than 2 wt. % contaminants). The feed material of Sample B was a −100 mesh sized sand that was 99 wt. % SiO₂. The feed material of Sample C was SILVERBOND 325 ground crystalline silica, high purity quartz feed stock commercially available from Covia, containing about 99.5 wt. % SiO₂ and ground to −325 mesh sizing. Optical properties of the dry material were measured using an X-rite 9600 reflective spectrophotometer using a 25 mm diameter optical glass cuvette. The results are reported in Table 1. Bulk density (loose) was measured in accordance with ASTM C-29 and is reported in grams per milliliter (g/mL).

TABLE 1

| | | | | | Bulk Density |
|---|---|---|---|---|---|
| Sample | L* | a* | b* | Brightness | (loose) |
| Sample A | 74.3 | 3.84 | 15.20 | 35.20 | 1.35 g/mL |
| Sample B | 83.9 | 1.41 | 9.38 | 54.40 | 1.47 g/mL |
| Sample C | 94.2 | 0.62 | 4.05 | 80.80 | 1.05 g/mL |
| Comparative | 90.5 | 0.11 | 2.10 | 75.01 | 0.86 g/mL |
| Sample D | | | | | |

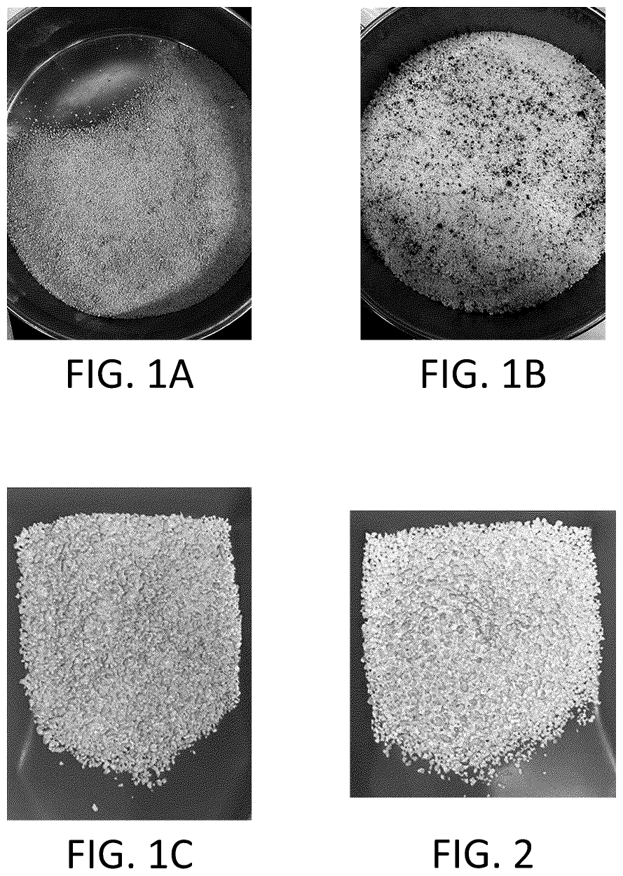

Comparative Sample D was prepared by subjecting the feed material of Sample A to heat treatment. In particular, a quantity of Sample A sand was combined with 0.2 wt. % sodium hydroxide and heated to 1525° C. for 60 minutes in a rotary kiln to convert the SiO₂ from quartz to cristobalite without first grinding and agglomerating the feed material of Sample A into granules. Optical properties and bulk density were measured as described above and are reported in Table 1. Photographs of Sample A and Comparative Sample D are provided as FIGS. 1A and 1B, respectively.

As can be seen in FIGS. 1A and 1B, black specks appear in the coarse cristobalite grit after heat treatment. It is believed that these black specks are iron oxide that appears yellowish in the feedstock of Sample A but turns into black specks as a result of changing from one form to another during heating. Mica and other minerals that are present as contaminants in the feedstock of Sample A also show up as specks and are present in Comparative Sample D as black specks. Thus, although the cristobalite itself appears white and brighter as compared to the feed material, the black specks may render the product unsuitable for its intended use. Simply heating the feed material does not reduce the appearance of black specks.

Next, Samples E, F, and G were prepared by granulating the feed materials of Samples A, B, and C, respectively. In particular, a quantity of Samples A, B, and C was milled to approximately −325 mesh which equates to a range of from about 0.5 μm to 50 μm with a mean particle size of from about 10-15 μm, granulated with 5 wt. % water glass (40% sodium silicate), and fired at 1350° C. for 60 minutes in a rotary kiln. Samples E and F were granulated using lab-grade granulation equipment, while Sample G was granulated using an Eirich granulator. Optical properties and bulk density were measured as described above and are reported in Table 2. Photographs of the granulated Sample E and Sample F are provided as FIGS. 1C and 2, respectively.

TABLE 2

| | | | | | Bulk Density |
|---|---|---|---|---|---|
| Sample | L* | a* | b* | Brightness | (loose) |
| Sample E | 92.3 | 0.22 | 3.71 | 77.02 | 0.55 |
| Sample F | 93.9 | 0.31 | 1.87 | 82.6 | 0.52 |
| Sample G | 97.2 | −0.18 | 1.09 | 91.53 | 0.76 |

Comparing FIG. 1C to FIG. 1B, it can be seen that the milling and agglomeration is effective to eliminate the appearance of the black specks in the granule. For Sample E, the processing increases the lightness of the product (e.g., increases the L* value) and the brightness of the product as compared to both Comparative Sample D and the feed material of Sample A. Similarly, the processing is effective to increase the lightness (L* value) and the brightness of Samples F and G as compared to the feed materials of Samples B and C, respectively. Accordingly, the values in Table 2 demonstrate that the process described herein is effective to produce a product that does not have black specks and is brighter as compared to the feed material without subjecting the feed material to a cleaning or decontamination process.

Moreover, comparing FIG. 1C to FIG. 2 and the values in Tables 1 and 2, it can be seen that although the material of Sample F is brighter than the material of Sample E, the feed material from which Sample F is made is of higher quality than the feed material from which Sample E is made. However, the resulting granules of Sample E exhibit an L* value of greater than 92, suggesting that these granules are at least comparable to conventional solar reflecting roofing granules.

Although the granulation process significantly decreases the bulk density of Samples E-G as compared to the feed materials of Samples A-C, it is believed that the bulk density of Samples E and F may be exceedingly low due to the laboratory granulation process used instead of using a commercial-grade granulator, as in Sample G.

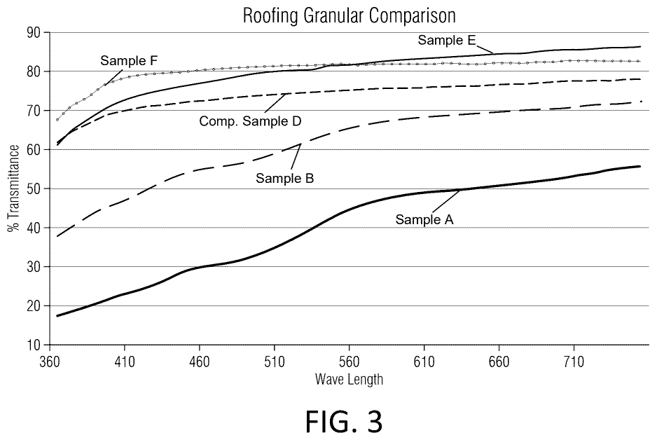

In addition to the L*, a*, and b* values, average visible light reflection for each of the samples described above was measured over wavelengths from 360 nm to 750 nm. The % reflectance (Y-axis) as a function of wavelength (X-axis) is presented as a graph in FIG. 3. The average visible light reflection for each of the samples is reported in Table 3.

TABLE 3

| Sample | Average Reflection |
|---|---|
| Sample A | 40.1 |
| Comparative Sample D | 74.0 |
| Sample E | 79.8 |
| Sample B | 61.2 |
| Sample F | 80.5 |
| Sample C | N/A |
| Sample G | 91.3 |

As shown in Table 3 and FIG. 3, the average visible light reflection is comparable between the granulated materials in Samples E and F, and the reflection is significantly higher than that of the feed materials in Samples A and B (not shown in FIG. 3). As compared to the granulated Samples E and F, the average visible light reflection is significantly lower for the unground and ungranulated Comparative Sample D. Sample G exhibits the highest average visible light reflection values, which can be attributed to the use of a commercial-grade granulator. It is believed that the commercial-grade equipment used to prepare Sample G provided rounder and more consistent granules as compared to the lab-grade equipment used to prepare Samples E and F.

### Example 2

Next, the amount of sodium silicate was varied to further explore the impact of the fluxing agent on the cristobalite product. For each sample, 5 lbs (2268 g) of quartz silica powder with an average particle size of 325 μm was loaded into an Eirich mixer, and an appropriate amount (see Table 4) of technical grade sodium silicate (40% solution) was weighted out in a 500 mL graduated cylinder. The graduated cylinder was filled to 500 mL with distilled water and the contents of the graduated cylinder was added to the Eirich mixer. The Eirich mixer was closed and turned on to “low” speed for approximately one minute before being turned to “high” speed for approximately two additional minutes. Nex, the central blades were turned off and the bowl was permitted to spin for an additional one minute. Then, approximately 125 g of additional quartz silica powder was dusted in and the bowl was permitted to spin for another minute before the mixture was removed from the mixer.

TABLE 4

| | | Quartz | Sodium | Water |
|---|---|---|---|---|
| Formula | Final Concentration | Powder (g) | Silicate (g) | (g) |
| 1 | 2 wt. % sodium silicate | 2268 g | 113.5 g | 408.8 g |
| 2 | 4 wt. % sodium silicate | 2268 g | 226.9 g | 330.1 g |
| 3 | 6 wt. % sodium silicate | 2268 g | 340.3 g | 245.3 g |
| 4 | 8 wt. % sodium silicate | 2268 g | 453.6 g | 164.9 g |

The mixture was dried overnight in a convection oven with the blower operating, but without using any heat. The resulting mixture was screened to obtain granules having a size of −8+35 (i.e., greater than 35 mesh and smaller than 8 mesh). A platinum dish was loaded with approximately 250 g of screened granules and placed into a box furnace set to the predetermined temperature (see Table 5) for one hour. The dish was then removed from the furnace and cooled to room temperature.

TABLE 5

| | Temperature | | | | | Specific Gravity |
|---|---|---|---|---|---|---|
| Formula | (° C.) | L* | a* | b* | Brightness | (g/cm³) |
| 1 | 1300° C. | 95.7 | −1.3 | 4.1 | 84.6 | 2.35 |
| 2 | 1300° C. | 95.9 | −1.3 | 4.1 | 84.9 | 2.34 |
| 3 | 1300° C. | 94.8 | −1.6 | 4.8 | 81.6 | 2.34 |
| 4 | 1300° C. | 93.4 | −1.4 | 4.4 | 79.0 | 2.33 |
| 1 | 1350° C. | 95.2 | −1.0 | 3.3 | 83.3 | 2.34 |
| 2 | 1350° C. | 95.0 | −1.0 | 3.3 | 83.0 | 2.33 |
| 3 | 1350° C. | 94.1 | −1.3 | 4.2 | 80.8 | 2.33 |
| 4 | 1350° C. | 93.9 | −1.3 | 4.3 | 80.3 | 2.33 |
| 1 | 1400° C. | 95.5 | −1.1 | 3.4 | 85.0 | 2.33 |
| 2 | 1400° C. | 95.1 | −1.2 | 3.8 | 83.7 | 2.33 |
| 3 | 1400° C. | 95.2 | −1.4 | 4.2 | 83.4 | 2.33 |
| 4 | 1400° C. | 94.6 | −1.3 | 3.9 | 82.2 | 2.33 |

As shown in Table 5, for each of the concentrations of sodium silicate between 2 wt. % and 8 wt. % and for each of the temperatures between 1300° C. and 1400° C., the samples exhibited an L* value of 93-98, an a* value between 1.0 and 1.6, a b* value between 3.3 and 4.8, with a brightness greater than 79 and a specific gravity of from about 2.32 to about 2.40.

X-ray powder diffraction (XRPD) analysis was performed on each of the samples in Table 5 to determine the morphology of the resulting granules. Each sample was separated into three (3) splits weighing 4 g. Each split was mixed with 20 wt. % (1 g) of corundum powder and milled to ensure optimal particle size distribution. A Phillips X'Pert Pro PW3040 diffractometer equipped with a variable divergence slit set to a 16 mm exposure area, 15 mm incident beam mask, and 0.04 radian primary and secondary soller slits. Samples were loaded into a sample holder with a 27 mm internal diameter. Measurements were performed on a rotating sample holder (8 rpm) using a continuous scanning mode in Bragg-Brentano geometry with Cu-Kα radiation (40 kV and 40 mA, step size of 0.026 °2θ in a 5 to 64 °2θ range with a total measurement time of 62 minutes.

Using a Profex graphical user interface, the BGMN program was utilized for Rietveld refinement. The BGMN program is described in greater detail in “BGMN—a new fundamental parameters based Rietveld program for laboratory X-ray sources, its use in quantitative analysis and structure investigations” by J. Bergman et al., CPD Newsletter 20, no. 5 (1998): 5-8, the entire contents of which is hereby incorporated by reference. Structural parameters of the analyzed phases were obtained from a Crystallography Open Database and BGMN structure file repository. For each identified phase, lattice, peak-broadening parameters, and preferred orientation (if warranted) were refined within physically acceptable parameters. Corundum was used as an internal standard to approximate the proportion of amorphous matter in the sample.

XRPD analysis was performed in triplicate and the average weight percentage of each of cristobalite, quartz, tridymite, and amorphous silica based on a total amount of silica for each sample are provided in Table 6.

TABLE 6

| | Temperature | Cristobalite | Quartz | Tridymite | Amorphous |
|---|---|---|---|---|---|
| Formula | (° C.) | (wt. %) | (wt. %) | (wt. %) | (wt. %) |
| 1 | 1300° C. | 69.4 | 3.8 | 2.9 | 23.8 |
| 2 | 1300° C. | 71.0 | 0.6 | 5.4 | 23.0 |
| 3 | 1300° C. | 67.1 | 0.5 | 10.4 | 22.0 |
| 4 | 1300° C. | 58.7 | 0.2 | 21.4 | 19.7 |
| 1 | 1350° C. | 71.2 | 0.8 | 3.0 | 24.9 |
| 2 | 1350° C. | 72.4 | 0.3 | 5.6 | 21.8 |
| 3 | 1350° C. | 67.4 | 0.2 | 11.4 | 21.0 |
| 4 | 1350° C. | 63.5 | 0.0 | 20.7 | 15.7 |
| 1 | 1400° C. | 74.8 | 0.3 | 2.3 | 22.6 |
| 2 | 1400° C. | 78.4 | 0.1 | 3.9 | 17.5 |
| 3 | 1400° C. | 72.6 | 0.1 | 10.9 | 16.5 |
| 4 | 1400° C. | 69.2 | 0.0 | 15.2 | 15.5 |

As shown in Table 6, the combination of sodium silicate and heat treatment at a temperature between 1300° C. and 1400° C. was sufficient to convert the crystalline quartz material into a silica including predominately cristobalite (e.g., greater than 60 wt. % cristobalite based on the total amount of silica). Each of the samples also included less than 5 wt. % quartz (most less than 1 wt. % or even less than 0.5 wt. %), from 2 wt. % to 22 wt. % tridymite, and from 15.5 wt. % to 25 wt. % amorphous silica based on the total amount of silica. Although the sample including 2 wt. % sodium silicate (Formula 1) treated at 1300° C. included approximately 3.8 wt. % quartz, it was demonstrated that increasing the amount of sodium silicate, increasing the temperature, or both was sufficient to convert greater than 99 wt. % of the quartz. However, cristobalite was the predominant crystalline form for all of the samples tested.

Often times, the commonly used commercial nomenclature refers only to the crystalline portion of the roofing materials; and in such instances, the cristobalite portion of the crystalline silica content of all of the tested samples is greater than 73%, and in the samples formed using 2%, 4% and 6% sodium silicate, the cristobalite ranges from 85.3% to 96.6% of the crystalline content of the samples as shown in Table 7.

TABLE 7

| | Temperature | Cristobalite | Quartz | Tridymite |
|---|---|---|---|---|
| Formula | (° C.) | (wt. %) | (wt. %) | (wt. %) |
| 1 | 1300° C. | 91.1 | 5.0 | 3.8 |
| 2 | 1300° C. | 92.3 | 0.8 | 7.0 |
| 3 | 1300° C. | 86.0 | 0.6 | 13.4 |
| 4 | 1300° C. | 73.1 | 0.2 | 26.7 |
| 1 | 1350° C. | 94.9 | 1.1 | 4.0 |
| 2 | 1350° C. | 92.5 | 0.3 | 7.1 |
| 3 | 1350° C. | 85.3 | 0.3 | 14.5 |
| 4 | 1350° C. | 75.4 | 0.0 | 24.6 |
| 1 | 1400° C. | 96.6 | 0.4 | 2.9 |
| 2 | 1400° C. | 95.1 | 0.1 | 4.7 |
| 3 | 1400° C. | 86.9 | 0.1 | 13.0 |
| 4 | 1400° C. | 81.9 | 0.0 | 18.0 |

The strength of the granules was also tested. Granules were prepared as described above in Table 4, screened to obtain granules having a size of −8+35, and calcined at a temperature of 1300° C., 1350° C., or 1400° C. Next, approximately 20 g of each sample was measured and dispensed into the bottom of a crush cell using a crush cell funnel. The plunger was inserted into the cell bottom and allowed to float down. The loaded crush cell was then put onto the lower press platen and the load cell was placed on top of the crush cell plunger. A Monogram benchtop controller was then turned on and tared, and the lever was pumped until the load cell contacted the upper platen. The lever was then pumped until the controller displayed 1,000 lbs of force. The sample was subjected to the force for five (5) minutes; during the 5-minute period, the lever was gently tapped as needed to maintain a force between 1,000 lbs and 1,050 lbs. When the timer expired, the force was removed and the crush cell was carefully opened.

The sample was poured into a #35 mesh screen with a solid pan on the bottom. The screen was put on a sieve shaker on speed five (5) for one (1) minute and turned as needed to ensure good coverage of the sample on the screen. The sample on the screen was then discarded and the weight of the fines in the solid pan was measured and recorded. Each sample was repeated in triplicate, and the average percent of fines created is reported in Table 8 below. The percent of fines created was calculated by dividing the mass of the fines by the initial sample mass and multiplied by 100.

TABLE 8

| | Temperature | Average % Fines |
|---|---|---|
| Formula | (° C.) | Created |
| 1 | 1300° C. | 6.0 |
| 2 | 1300° C. | 4.5 |
| 3 | 1300° C. | 2.2 |
| 4 | 1300° C. | 1.0 |
| 1 | 1350° C. | 6.1 |
| 2 | 1350° C. | 3.6 |
| 3 | 1350° C. | 1.6 |
| 4 | 1350° C. | 1.3 |
| 1 | 1400° C. | 6.2 |
| 2 | 1400° C. | 3.8 |
| 3 | 1400° C. | 2.1 |
| 4 | 1400° C. | 1.7 |

As shown in Table 8, the percentage of fine particles created by the breakage of the granules decreased with increasing amount of sodium silicate regardless of the calcining temperature, indicating that increasing the amount of sodium silicate results in stronger granules.

Although only a few embodiments of this invention have been described above, it should be appreciated that many modifications can be made without departing from the spirit and scope of the invention. All such modifications are intended to be included within this invention, which is to be limited only by the following claims.

1. A process for producing a white silica-based product comprising:
milling a feed material to form a milled feed material having a size of from about 0.5 μm to about 50 μm;
combining the milled feed material with sodium silicate and water to provide an agglomerated mixture; and
heating the agglomerated mixture for a time and at a temperature of from about 1300° C. to less than about 1550° C. to thereby form the white silica-based product, wherein the agglomerated mixture is heated sufficiently so that cristobalite is the predominant silica crystal structure in the white silica-based product and further so that the white silica-based product exhibits an L* value in the CIELAB color space of 93-98.

2. The process of claim 1, wherein the feed material is derived from a waste sand by-product produced from a sand plant.

3. The process of claim 1, wherein the sodium silicate is present in an amount of from about 0.2 wt. % to about 10 wt. % based on a total weight of the agglomerated mixture.

4. The process of claim 1, wherein the sodium silicate is present in an amount of from about 1 wt. % to about 5 wt. % based on a total weight of the agglomerated mixture.

5. The process of claim 1, wherein the water is present in an amount of from about 10 wt. % to about 20 wt. % based on a total weight of the agglomerated mixture.

6. The process of claim 1, wherein the agglomerated mixture further comprises sodium hydroxide.

7. The process of claim 1, wherein the sodium silicate and the water are applied to the milled feed material via spraying.

8. The process of claim 1, wherein the heating comprises heating the agglomerated mixture to a temperature of from about 1350° C. to about 1400° C.

9. The process of claim 1, wherein the heating is carried out for a time of from about 40 minutes to about 60 minutes.

10. The process of claim 1, wherein the heating is effective to sinter particles of the agglomerated mixture into granules.

11. The process of claim 1, further comprising cooling the white silica-based product to a temperature of about 100° C. or less.

12. The process of claim 1, further comprising applying at least one coating to granules of the white silica-based product at a temperature of from about 75° C. to about 100° C.

13. The process of claim 1, further comprising applying at least one coating to granules of the white silica-based product at a temperature of less than 50° C.

14. The process of claim 1, further comprising sieving the white silica-based product to select white silica-based granules having an average particle size of from about 0.45 mm to about 2.5 mm.

15. The process of claim 14, whereby the sieving is effective to create an over-sized white silica fraction and an under-sized white silica fraction, the process further comprising:
combining the over-sized white silica fraction and the under-sized white silica fraction; and
milling the combined fractions, thereby producing a white silica-based powder having a maximum mesh size of 325 mesh.

16. The process of claim 1, wherein the white silica-based granules have a specific gravity of from about 2.32 to about 2.40.

17. A roofing granule comprising a white silica-based granule exhibiting an L* value in the CIELAB color space of 93-98, wherein cristobalite is the predominant crystal structure of silica in the white silica-based granule.

18. The roofing granule of claim 17, wherein the roofing granule has an average particle size of from about 0.45 mm to about 2.5 mm.

19. The roofing granule of claim 17, wherein the roofing granule has a specific gravity of from about 2.32 to about 2.40.

20. The roofing granule of claim 17, wherein the roofing granule has a functional coating on an exterior surface of the white silica-based granule.

21. A white silica-based granule exhibiting a visible light reflection greater than 75% in the 360 nm to 750 nm wavelength range and at least one of the following:
an L* value in the CIELAB color space of 93-98; or
cristobalite is the predominant silica crystal structure; or
the granule has a specific gravity of from about 2.32 to about 2.40.
